(19) United States
(12) Patent Application Publication
(10) Pub. No.: US 2026/0177969 A1
(43) Pub. Date: Jun. 25, 2026

(54) IMAGE FORMING APPARATUS

(71) Applicant: CANON KABUSHIKI KAISHA, Tokyo (JP)

(72) Inventors: TAKANORI YAMAMOTO, Shizuoka (JP); OSAMU NAGASAKI, Shizuoka (JP); TERUHIKO SASAKI, Shizuoka (JP); AKINOBU HIRAYAMA, Shizuoka (JP); MOTOHIRO FURUSAWA, Shizuoka (JP); YOSHIYUKI YAMAZAKI, Okinawa (JP)

(21) Appl. No.: 19/415,019

(22) Filed: Dec. 10, 2025

(30) Foreign Application Priority Data
Dec. 19, 2024 (JP) 2024-224575

(51) Int. Cl. G03G 21/12; G03G 15/01; G03G 15/08; G03G 15/16; G03G 21/00; G03G 21/16; G03G 21/18

(52) U.S. Cl. CPC G03G 21/12; G03G 15/0121; G03G 15/0131; G03G 15/0189; G03G 15/0875; G03G 15/161; G03G 15/167; G03G 21/0011; G03G 21/1633; G03G 21/1814

(57) ABSTRACT

An image forming apparatus includes an apparatus main body including a photosensitive drum, a belt, a transfer member for transferring a toner image on the belt to a recording material, a development unit, a toner storage unit, and at least one of a collection member configured to collect residual toner and a blade. The toner container stores toner to be supplied to the toner storage unit, the residual toner container stores at least either one of residual toner scraped off by the blade on the photosensitive drum and residual toner collected by the collection member from the belt, and is provided on one end side of the photosensitive drum in the axis line direction. A removing direction of the toner container from the apparatus main body is an upper direction of the gravitational force direction, and a part of the outer casing member is attached to the residual toner container.

### BACKGROUND

### Field of the Technology

The present disclosure relates to an image forming apparatus that forms an image on a sheet.

### Description of the Related Art

U.S. Pat. No. 7,831,168 describes an image forming apparatus including a plurality of photosensitive drums, a primary transfer roller that transfers a toner image formed on each photosensitive drum to an intermediate transfer belt, and a secondary transfer roller that transfers a full-color toner image on the intermediate transfer belt to a recording material. After the toner image is transferred by the primary transfer roller from each photosensitive drum to the intermediate transfer belt, waste toner remaining on the photosensitive drum is removed by a cleaning blade, and conveyed by an auger to a waste toner container. The waste toner container is exposed by opening a door provided on an apparatus main body of the image forming apparatus, and configured to be detachably attached to the apparatus main body.

Nevertheless, there remains room for further improvement in the prior art described in U.S. Pat. No. 7,831,168. In view of the foregoing, the present disclosure is directed to further development of the prior art.

### SUMMARY

According to an aspect of the present disclosure, an image forming apparatus includes an apparatus main body, an outer casing member constituting an outer casing of the image forming apparatus, a toner container detachably attached to the apparatus main body, and a residual toner container detachably attached to the apparatus main body independently of the toner container, wherein the apparatus main body includes a photosensitive drum rotatable about a rotational axis line extending in an axis line direction intersecting with a gravitational force direction, a belt to which a toner image on the photosensitive drum is to be transferred, a transfer member for transferring a toner image on the belt to a recording material, a development unit configured to develop a toner image by supplying toner to the photosensitive drum, a toner storage unit configured to store toner to be borne by the development unit, and at least either one of a collection member configured to collect residual toner remaining on the belt without being transferred to a recording material and a blade configured to scrape off residual toner remaining on the photosensitive drum without being transferred to the belt, by coming into contact with the photosensitive drum, wherein the toner container stores toner to be supplied to the toner storage unit, wherein the residual toner container stores at least either one of residual toner scraped off by the blade on the photosensitive drum and residual toner collected by the collection member from the belt, and is provided on one end side of the photosensitive drum in the axis line direction, wherein a removing direction of the toner container from the apparatus main body is an upper direction of the gravitational force direction, and wherein a part of the outer casing member is attached to the residual toner container.

According to another aspect of the present disclosure, an image forming apparatus includes an apparatus main body including an attachment portion, an outer casing member constituting an outer casing of the image forming apparatus, a toner container detachably attached to the attachment portion of the apparatus main body, and a residual toner container detachably attached to the apparatus main body independently of the toner container, wherein the apparatus main body includes a photosensitive drum rotatable about a rotational axis line extending in an axis line direction intersecting with a gravitational force direction, a belt to which a toner image on the photosensitive drum is to be transferred, a transfer member for transferring a toner image on the belt to a recording material, a development unit configured to develop a toner image by supplying toner to the photosensitive drum, a toner storage unit configured to store toner to be borne by the development unit, at least either one of a collection member configured to collect residual toner remaining on the belt without being transferred to a recording material and a blade configured to scrape off residual toner remaining on the photosensitive drum without being transferred to the belt, by coming into contact with the photosensitive drum, and an opening/closing member movable between a closed position at which the attachment portion is closed and an open position at which the attachment portion is opened, wherein the toner container stores toner to be supplied to the toner storage unit, wherein the residual toner container stores at least either one of residual toner scraped off by the blade on the photosensitive drum and residual toner collected by the collection member from the belt, and is provided on one end side of the photosensitive drum in the axis line direction, wherein a part of the outer casing member is attached to the residual toner container, and wherein the residual toner container is configured to be removable from the apparatus main body when the opening/closing member is located at the closed position.

According to the present disclosure, it is possible to further improve the prior art.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating an image forming apparatus according to a first embodiment.

FIG. 2A is a perspective view illustrating the image forming apparatus in a state in which a toner cartridge door is located at a closed position, and FIG. 2B is a perspective view illustrating the image forming apparatus in a state in which the toner cartridge door is located at an open position.

FIG. 3 is a perspective view illustrating a state in which a process cartridge and a waste toner container are removed from an apparatus main body of the image forming apparatus.

FIG. 4 is a perspective view illustrating the image forming apparatus from which a toner cartridge is removed.

FIG. 5 is a perspective view illustrating a process unit from which the toner cartridge is removed.

FIG. 6 is a perspective view illustrating a back side of the waste toner container.

FIG. 7A is a perspective view illustrating the image forming apparatus to which the waste toner container is attached, and FIG. 7B is a perspective view illustrating the image forming apparatus from which the waste toner container is removed.

FIG. 8A is a cross-sectional view illustrating the waste toner container attached to the apparatus main body, and FIG. 8B is a cross-sectional view illustrating the waste toner container removed from the apparatus main body.

FIG. 9A is a perspective view illustrating an image forming apparatus according to a second embodiment that is in a state in which a toner cartridge door is located at a closed position, and FIG. 9B is a perspective view illustrating the image forming apparatus in a state in which the toner cartridge door is located at an open position.

FIG. 10A is a perspective view illustrating the image forming apparatus to which a waste toner container is attached, and FIG. 10B is a perspective view illustrating the image forming apparatus from which the waste toner container is removed.

### DESCRIPTION OF THE EMBODIMENTS

Embodiments of the present disclosure will be described in detail with reference to the drawings. The dimensions, materials, and shapes of the components to be described in the embodiments, and their relative arrangement are to be appropriately changed depending on the configuration of an apparatus to which the invention is applied, and various conditions. That is, these are not intended to limit the scope of the invention to the following embodiments. In addition, a plurality of features are described in the embodiments, but not all of the plurality of features are always essential to the invention, and the plurality of features may be arbitrarily combined. Furthermore, in the accompanying drawings, the same or similar components are assigned the same reference numerals, and the redundant description will be omitted.

As a normally-expected installation state, an image forming apparatus according to the present embodiment is placed on a horizontal installation surface. Accordingly, axes and directions in the drawings are defined as follows.

An X-axis and a Y-axis in the drawings extend parallel to a horizontal direction, and a Z-axis extends in a vertical direction (gravitational force direction). Regarding the X-axis, a direction indicated by an arrow of the X-axis is defined as an X direction, and a direction opposite to the X direction is defined as a −X direction. In addition, the X direction will also be sometimes referred to as a right direction, and the −X direction will also be sometimes referred to as a left direction. Regarding the Y-axis, a direction indicated by an arrow of the Y-axis is defined as a Y direction, and a direction opposite to the Y direction is defined as a −Y direction. In addition, the Y direction will also be sometimes referred to as a front direction, and the −Y direction will also be sometimes referred to as a back direction. Regarding the Z-axis, a direction indicated by an arrow of the Z-axis is defined as a Z direction, and a direction opposite to the Z direction is defined as a −Z direction. In addition, the Z direction will also be sometimes referred to as an upper direction, and the −Z direction will also be sometimes referred to as a down direction. The X direction, the Y direction, and the Z direction are orthogonal to each other.

### First Embodiment

### [Overall Configuration]

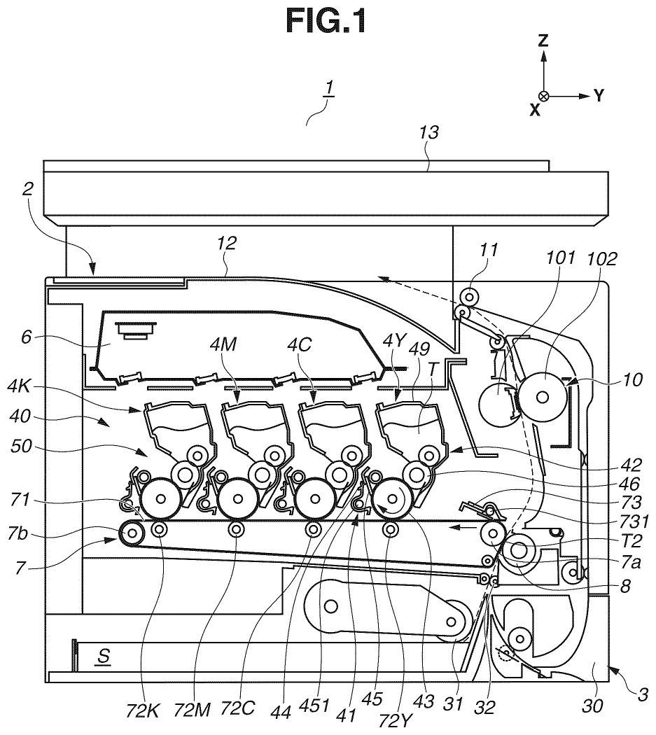

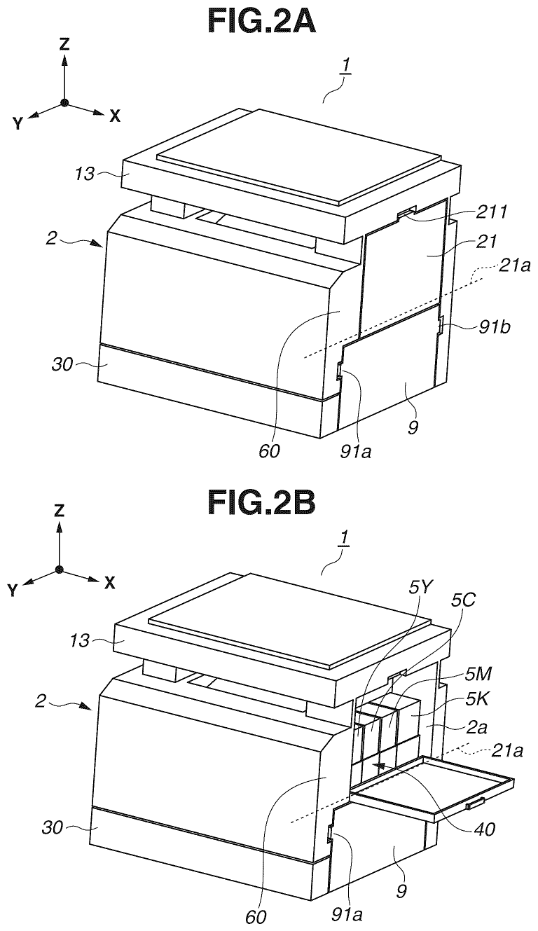

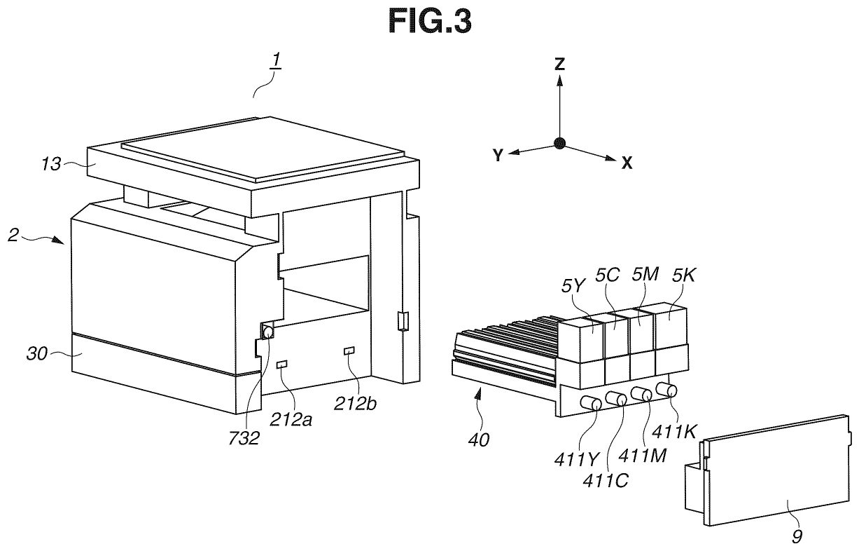

First of all, the first embodiment of the present disclosure will be described. FIG. 1 is a cross-sectional view illustrating an electrophotographic image forming apparatus 1 according to the first embodiment. FIG. 2A is a perspective view illustrating the image forming apparatus 1 in a state in which a toner cartridge door 21 is located at a closed position, and FIG. 2B is a perspective view illustrating the image forming apparatus 1 in a state in which the toner cartridge door 21 is located at the open position. FIG. 3 is a perspective view illustrating a state in which a process cartridge 4 and a waste toner container 9 are removed from an apparatus main body 2 of the image forming apparatus 1.

As illustrated in FIG. 1, the image forming apparatus 1 is an electrophotographic laser beam printer.

The image forming apparatus 1 includes the apparatus main body 2, and a document reading unit 13 provided above the apparatus main body 2. The document reading unit 13 includes a platen on which a document is to be placed, and a reading unit that reads an image or character information recorded on the document placed on the platen.

The image forming apparatus includes a printer, a copier, a facsimile, and a multifunction peripheral, and refers to an apparatus that forms an image on a sheet to be used as a recording medium, based on image information input from an external personal computer (PC), or image information read from a document. In addition, an accessory device such as an optional feeder, an image reading device, and a sheet processing device is sometimes connected to the image forming apparatus in addition to a main body having an image forming function. The entire system to which such an accessory device is connected is also regarded as one type of an image forming apparatus.

The apparatus main body 2 includes an image forming unit 50 that forms an image on a sheet S serving as a recording material, a feeding unit 3, a fixing unit 10, and a discharge roller pair 11. The image forming unit 50 includes a process unit 40, an intermediate transfer unit 7 arranged below the process unit 40, and a scanner unit 6 arranged above the process unit 40.

The sheet S includes a sheet such as paper including a form and an envelope, a plastic film such as an overhead projector (OHP) sheet, and cloth.

The process unit 40 includes four process cartridges 4Y, 4C, 4M, and 4K that form four-color toner images corresponding to yellow (Y), cyan (C), magenta (M), and black (K), respectively. The process cartridges 4Y, 4C, 4M, and 4K are arranged in an approximately-horizontal direction (the Y direction). The order of the process cartridges 4Y, 4C, 4M, and 4K may be arbitrarily set. For example, the four process cartridges may be arranged in an approximately-horizontal direction in the order of the process cartridges 4Y, 4M, 4C, and 4K.

In addition, the process unit 40 is configured to be detachably attached to a casing of the apparatus main body 2. The casing of the apparatus main body 2 includes, for example, a main body frame of the apparatus main body 2. For example, the process unit 40 may include a tray (support member) supporting the four process cartridges 4Y, 4C, 4M, and 4K, and by attaching and detaching the tray with respect to the casing of the apparatus main body 2, the process cartridges 4Y, 4C, 4M, and 4K integrally move. Alternatively, the process cartridges 4Y, 4C, 4M, and 4K may be configured to be independently attachable and detachable with respect to the casing of the apparatus main body 2.

The four process cartridges 4Y, 4C, 4M, and 4K have the same configuration except that the colors of images to be formed are different. Thus, the configuration and an image forming process of only the process cartridge 4Y will be described, and the description of the process cartridges 4C, 4M, and 4K will be omitted.

The process cartridge 4Y includes a cleaning unit 41 and a development unit 42. The cleaning unit 41 includes a photosensitive drum 43, a charging roller 44, a cleaning blade 45 serving as a blade, and a waste toner screw 451 for conveying waste toner to the waste toner container 9 to be described below. The photosensitive drum 43 can rotate about a rotational axis that extends in the X direction or in the −X direction, which are axis directions intersecting the gravitational force direction (the −Z direction). The development unit 42 includes a development roller 46, and a development container 49 serving as a toner storage unit that stores developer (hereinafter, referred to as toner) T. The development unit 42 is supported in such a manner as to be swingable with respect to the cleaning unit 41. The development unit 42 may be provided in such a manner as to be removable with respect to the cleaning unit 41, or may be provided integrally with the cleaning unit 41.

For example, when the process cartridge 4K is regarded as a first process cartridge, the photosensitive drum 43, the development roller 46, and the development container 49 of the process cartridge 4K, and a toner cartridge 5K to be described below that is to be attached to the process cartridge 4K can be regarded as a first photosensitive drum, a first development unit, a first toner storage unit, and a first toner container, respectively. In addition, when the process cartridge 4M is regarded as a second process cartridge, the photosensitive drum 43, the development roller 46, and the development container 49 of the process cartridge 4M, and a toner cartridge 5M to be attached to the process cartridge 4M can be regarded as a second photosensitive drum, a second development unit, a second toner storage unit, and a second toner container, respectively. The photosensitive drum 43 of the process cartridge 4M bears a toner image of a color different from the color of a toner image on the photosensitive drum 43 of the process cartridge 4K. The photosensitive drum 43 of the process cartridge 4K and the photosensitive drum 43 of the process cartridge 4M are arranged in the Y direction (intersecting direction, first intersecting direction, and second intersecting direction). Similarly, the toner cartridges 5M and 5K are arranged in the Y direction (refer to FIG. 2B). That is, an alignment direction of the photosensitive drum 43 of the process cartridge 4K and the photosensitive drum 43 of the process cartridge 4M, and an alignment direction of the toner cartridges 5M and 5K are the same directions as each other. That is, the photosensitive drum 43 of the process cartridge 4K and the photosensitive drum 43 of the process cartridge 4M are configured to be removable from the apparatus main body 2 as an integrated process unit 40 (unit).

In the present embodiment, each process cartridge (for example, the process cartridge 4K) is provided with the photosensitive drum 43 and the development roller 46, but the configuration is not limited to this. For example, the development roller 46 may be provided in a toner cartridge (for example, the toner cartridge 5K) to be detachably attached to a process cartridge, instead of providing the development roller 46 in the process cartridge. That is, the toner cartridge may include the development roller 46 and a toner storage unit that stores toner to be borne by the development roller 46.

The intermediate transfer unit 7 includes an intermediate transfer belt 71 which is a belt stretched around a drive roller 7a, a tension roller 7b, and the like, and primary transfer rollers 72Y, 72C, 72M, and 72K arranged inside the intermediate transfer belt 71. A belt cleaning unit 73 serving as a collection member that scrapes off waste toner, which is residual toner remaining on the intermediate transfer belt 71, is provided above the drive roller 7a. The waste toner scraped off by the belt cleaning unit 73 is conveyed by a waste toner screw 731 to the waste toner container 9. In addition, a secondary transfer roller 8 serving as a transfer member is provided facing the drive roller 7a across the intermediate transfer belt 71. The intermediate transfer belt 71 and the secondary transfer roller 8 form a transfer nip T2 at which an image is transferred to the conveyed sheet S.

The feeding unit 3 includes a cassette 30 that is provided in a lower part of the image forming apparatus 1, and stores the sheet S, and a pickup roller 31 that feeds the sheet S stored in the cassette 30. The feeding unit 3 also includes a conveyance roller pair 32 that conveys the sheet S fed by the pickup roller 31, toward the transfer nip T2. The cassette 30, which is a drawer unit, is drawable in the Y direction and insertable into the apparatus main body 2 in the −Y direction. The fixing unit 10 includes a heating unit 101 that heats a toner image on the sheet S and a pressure roller 102 that comes into pressure contact with the heating unit 101.

Next, an image forming operation of the image forming apparatus 1 having the above-described configuration will be described. If an image signal is input to the scanner unit 6 from a PC (not illustrated) or the document reading unit 13, a laser beam corresponding to the image signal is emitted from the scanner unit 6 onto the photosensitive drum 43 of the process cartridge 4Y.

The surface of the photosensitive drum 43 is uniformly charged in advance by the charging roller 44 to predetermined polarity and potential, and by the laser beam being emitted from the scanner unit 6, an electrostatic latent image is formed on the surface. Toner in the development container 49 is borne on the development roller 46 by a paddle (not illustrated). The electrostatic latent image formed on the photosensitive drum 43 is developed by the development roller 46 serving as a development unit, and a yellow (Y) toner image is formed on the photosensitive drum 43. At this time, the development unit 42 of the process cartridge 4Y is pressed by a development pressing unit (not illustrated) provided in the apparatus main body 2.

In a similar manner, laser beams are emitted from the scanner unit 6 also to the photosensitive drums 43 of the process cartridges 4C, 4M, and 4K. Cyan (C), magenta (M), and black (K) toner images are formed on the respective photosensitive drums 43. The toner images of the respective colors formed on the photosensitive drums 43 are transferred to the intermediate transfer belt 71 by the primary transfer rollers 72Y, 72C, 72M, and 72K, and conveyed up to the transfer nip T2 by the intermediate transfer belt 71 rotated by the drive roller 7a. An image forming process of each color is performed at a timing of overlapping a toner image on a primarily-transferred upstream toner image on the intermediate transfer belt 71.

Concurrently with the image forming process, the sheet S stored in the cassette 30 of the feeding unit 3 is fed by the pickup roller 31, and conveyed by the conveyance roller pair 32 at a predetermined conveyance timing in accordance with an image transfer timing at the transfer nip T2. Then, a full-color toner image on the intermediate transfer belt 71 is transferred to the sheet S at the transfer nip T2 by a secondary transfer bias applied to the secondary transfer roller 8.

The image forming apparatus 1 can also form a single-color or multicolor toner image on the sheet S using only a single desired process cartridge or a plurality of desired process cartridges.

Predetermined heat and pressure are applied by the heating unit 101 and the pressure roller 102 of the fixing unit 10 to the sheet S to which the toner image is transferred, and toner is melted and firmly stuck (fixed) to the sheet S.

The sheet S having passed through the fixing unit 10 is discharged by the discharge roller pair 11 to a discharge tray 12.

As illustrated in FIGS. 2A and 2B, on the downstream side surface in the X direction of the apparatus main body 2 of the image forming apparatus 1, the toner cartridge door 21 and the waste toner container 9 serving as a residual toner container are provided. That is, the waste toner container 9 is arranged on one end side in the axis line direction of each photosensitive drum 43 of the process unit 40. In other words, the waste toner container 9 is provided on the downstream side of each photosensitive drum 43 of the process unit 40 in the X direction.

The toner cartridge door 21 serving as an opening/closing member is arranged above the waste toner container 9, and is provided in such a manner as to be openable and closable about a pivot axis line 21a between a closed position (position illustrated in FIG. 2A), and an open position (position illustrated in FIG. 2B).

The pivot axis line 21a extends in the Y direction, and the toner cartridge door 21 is configured to pivot from the closed position toward the open position by pivoting downward in the gravitational force direction with respect to the apparatus main body 2. The toner cartridge door 21 covers an opening portion 2a of the apparatus main body 2 at the closed position, and opens the opening portion 2a to be exposed to the outside of the apparatus main body 2, at the open position.

As illustrated in FIGS. 2B and 3, when the process unit 40 is removed from the casing of the apparatus main body 2, a cover (not illustrated) that supports a shaft of the toner cartridge door 21 is removed from the apparatus main body 2. That is, the toner cartridge door 21 is configured to be removable in the X direction from the casing of the apparatus main body 2. In a state in which the toner cartridge door 21 is removed, the process unit 40 can be removed to the outside of the apparatus main body 2 through the opening portion 2a.

In the process unit 40, toner cartridges 5Y, 5C, 5M, and 5K serving as toner containers that can replenish the development containers 49 of the respective process cartridges 4Y, 4C, 4M, and 4K with toner are detachably provided. The toner cartridges 5Y, 5C, 5M, and 5K respectively store yellow (Y) toner, cyan (C) toner, magenta (M) toner, and black (K) toner. If it is detected, by a remaining amount detection unit (not illustrated) provided in the apparatus main body 2, that an amount of toner in the development container 49 has become a predetermined amount or less, toner is supplied from the toner cartridge 5 corresponding to the development container 49.

In the present embodiment, the image forming apparatus 1 includes the apparatus main body 2, an outer casing member 60 constituting an outer casing of the apparatus main body 2, the document reading unit 13, the toner cartridges 5Y to 5K, and the waste toner container 9. In other words, a portion obtained by excluding the outer casing member 60, the document reading unit 13, the toner cartridges 5Y to 5K, and the waste toner container 9 from the image forming apparatus 1 corresponds to the apparatus main body 2.

As illustrated in FIG. 3, in the process unit 40, waste toner delivery unit 411Y, 411C, 411M, and 411K for delivering waste toner conveyed from the waste toner screws 451 provided in the process cartridges 4, to the waste toner container 9 are provided. That is, the waste toner delivery units 411Y, 411C, 411M, and 411K communicate with conveyance paths of the waste toner screws 451 provided in the process cartridges 4Y, 4C, 4M, and 4K. In addition, in the apparatus main body 2, a waste toner delivery unit 732 for delivering waste toner scraped off by the belt cleaning unit 73 and conveyed by the waste toner screw 731 to the waste toner container 9 is provided. In the present embodiment, the waste toner delivery unit 732 is provided in the intermediate transfer unit 7.

The waste toner container 9 is supported in such a manner as to be attachable and detachable with respect to the apparatus main body 2, and receives waste toner from the waste toner delivery units 411Y, 411C, 411M, 411K, and 732 in a state of being attached to the apparatus main body 2. The waste toner delivery units 411Y, 411C, 411M, 411K, and 732 are formed into a hollow pipe shape in such a manner that waste toner can pass through thereinside.

### [Attachment and Detachment of Toner Cartridge]

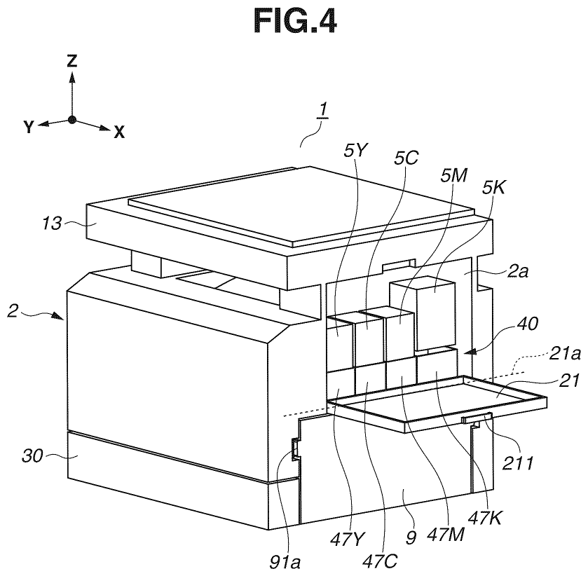

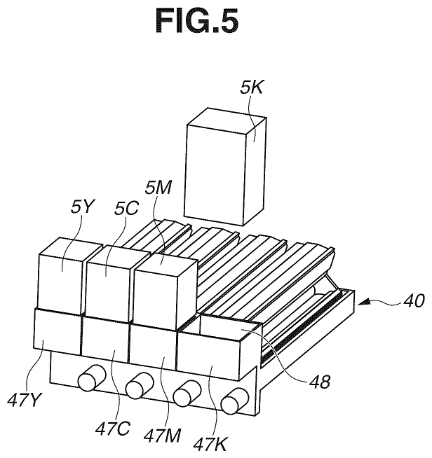

Next, a configuration for attaching and detaching the toner cartridge 5, and an attaching/detaching operation of the toner cartridge 5 will be described with reference to FIGS. 2A, 2B, 4, and 5. FIG. 4 is a perspective view illustrating the image forming apparatus 1 from which the toner cartridge 5K is removed. FIG. 5 is a perspective view illustrating the process unit 40 from which the toner cartridge 5K is removed.

First of all, the removal of the toner cartridge 5 will be described. As illustrated in FIGS. 2A and 2B, the toner cartridge door 21 is provided with a grip portion 211 that can be gripped by a user, and the user can access the grip portion 211 from a recess provided in the apparatus main body 2. In the present embodiment, the grip portion 211 is a protruding portion protruding upward when the toner cartridge door 21 is located at the closed position, but the grip portion 211 may be a recess portion or the like that is recessed in the −X direction or the −Z direction, for example, in place of the protruding portion. In addition, the grip portion 211 may be provided at any position on the toner cartridge door 21. Furthermore, the number of grip portions 211 is not limited to one, and a plurality of grip portions 211 may be provided.

In a case where toner in any of the toner cartridges 5Y, 5C, 5M, and 5K runs out, by displaying a message or an image on an operation panel (not illustrated), the image forming apparatus 1 notifies the user of an exchange timing of the toner cartridge 5Y, 5C, 5M, or 5K. If the user accesses the grip portion 211, and pivots the toner cartridge door 21 from the closed position to the open position, a switch (not illustrated) provided on the apparatus main body 2 is turned off. Then, the user becomes able to view the toner cartridges 5Y, 5C, 5M, and 5K attached to the process unit 40, from the opening portion 2a of the apparatus main body 2.

As illustrated in FIGS. 4 and 5, in the process unit 40, attachment portions 47Y, 47C, 47M, and 47K for attaching the toner cartridges 5Y, 5C, 5M, and 5K are provided. The four toner cartridges 5Y, 5C, 5M, and 5K have substantially the same configuration except that the colors of toner to be stored are different. In addition, the attachment portions 47Y, 47C, 47M, and 47K also have substantially the same configuration. Thus, only the configuration of the attachment portion 47K and an attaching/detaching operation of the toner cartridge 5K with respect to the attachment portion 47K will be described, and the description of an attaching/detaching operation of the toner cartridges 5Y, 5C, and 5M will be omitted.

The attachment portion 47K is formed into a box shape opened in the Z direction, and is formed to have an external form slightly larger than the toner cartridge 5K. In addition, the attachment portion 47K has a side surface 48 extending in the Z direction, and the side surface 48 has a rectangular cross-sectional shape in an XY-plane. In other words, the side surface 48 of the attachment portion 47K extends in the gravitational force direction or the vertical direction.

In addition, it can be said that the toner cartridge door 21 closes the attachment portions 47Y, 47C, 47M, and 47K at the closed position, and opens the attachment portions 47Y, 47C, 47M, and 47K at the open position.

By the user pulling the toner cartridge 5K to be exchanged upward in the Z direction (i.e., gravitational force direction), it is possible to remove the toner cartridge 5K from the process unit 40 in such a manner as to follow the side surface 48 of the attachment portion 47K. That is, when the toner cartridge 5K is attached to or detached from the process unit 40, the side surface 48 of the attachment portion 47K guides the toner cartridge 5K. In addition, a removing direction of the toner cartridge 5K from the apparatus main body 2 is an upper direction (the Z direction) of the gravitational force direction.

When the toner cartridge 5K is drawn up in the Z direction, upon unlocking of a lock mechanism (not illustrated) automatically, a toner supply port (not illustrated) provided on a downstream end surface of the toner cartridge 5K in the −Z direction (i.e., bottom surface) is simultaneously closed automatically as well. For this reason, even if there is toner remaining in the toner cartridge 5K, toner leakage and toner scattering can be reduced.

Next, the attachment of the toner cartridge 5K will be described. First of all, the user pushes the toner cartridge 5K downward in the −Z direction (i.e., vertical direction) in such a manner as to follow the side surface 48 of the attachment portion 47K provided in the process unit 40. The toner cartridge 5K is guided by the side surface 48 of the attachment portion 47K, and the toner cartridge 5K is inserted at a predetermined position of the process unit 40.

On the downstream end surface of the toner cartridge 5K in the −Z direction (i.e., bottom surface), the toner supply port (not illustrated) is provided, and if the toner cartridge 5K reaches a predetermined position, the toner supply port automatically opens, and is connected with a receiving port provided in the process unit 40. For example, the receiving port is provided in the development container 49 of the development unit 42. In addition, by the lock mechanism (not illustrated) automatically operating upon connection of the supply port of the toner cartridge 5K and the receiving port, the toner cartridge 5K is firmly attached to the process unit 40. The supply port of the toner cartridge 5K and the receiving port of the process unit 40 have a structure of keeping a hermetically-sealed state in such a manner as to minimize toner leakage by a sealing mechanism.

After the attachment of the toner cartridge 5K to the attachment portion 47K ends, the user pivots the toner cartridge door 21 from the open position to the closed position. Accordingly, an apparatus main body switch (not illustrated) is pressed, and the image forming apparatus 1 automatically starts toner supply from the toner cartridge 5K to the process unit 40. The image forming apparatus 1 thereby enters a state of being able to normally start printing, and an attaching operation of the toner cartridge 5K is completed.

### [Attachment and Detachment of Waste Toner Container]

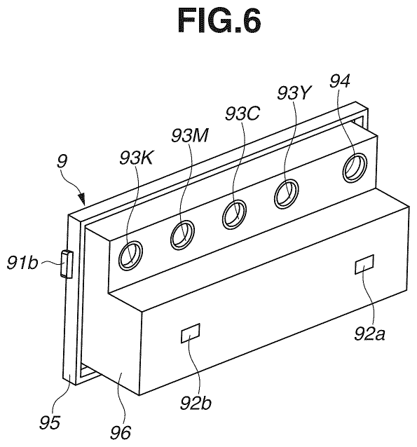

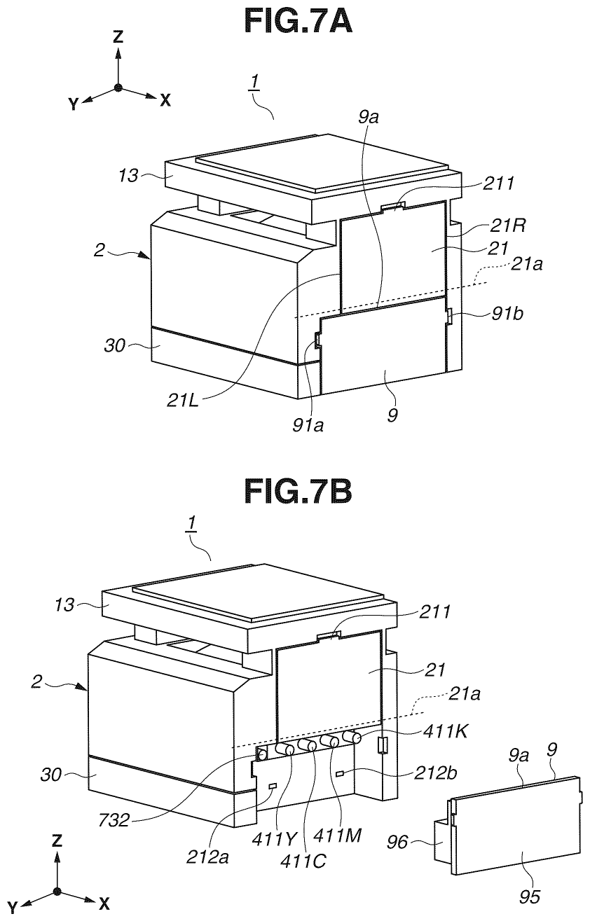

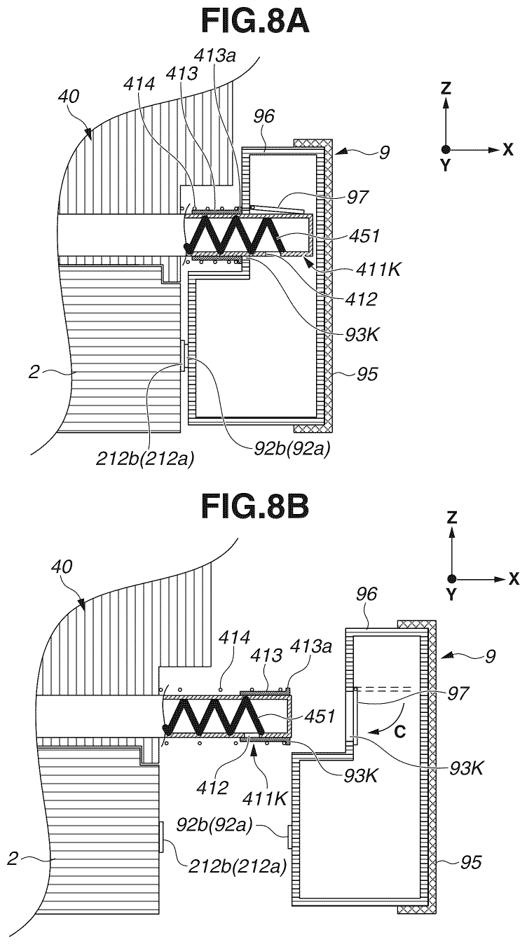

Next, a configuration for attaching and detaching the waste toner container 9, and an attaching/detaching operation of the waste toner container 9 will be described with reference to FIGS. 2A, 2B, 6 to 8B. FIG. 6 is a perspective view illustrating a back side of the waste toner container 9. FIG. 7A is a perspective view illustrating the image forming apparatus 1 to which the waste toner container 9 is attached, and FIG. 7B is a perspective view illustrating the image forming apparatus 1 from which the waste toner container 9 is removed. FIG. 8A is a cross-sectional view illustrating the waste toner container 9 attached to the apparatus main body 2, and FIG. 8B is a cross-sectional view illustrating the waste toner container 9 removed from the apparatus main body 2.

First, the configuration of the waste toner container 9 will be described. As illustrated in FIGS. 6 to 7B, the waste toner container 9 includes a waste toner collection box 96 for collecting and storing waste toner conveyed from the cleaning unit 41 and the belt cleaning unit 73.

Waste toner stored in the waste toner collection box 96 is discarded after the waste toner container 9 is removed from the apparatus main body 2.

In addition, the waste toner container 9 includes an outer casing member 95 for forming a part of the outer casing member 60 of the image forming apparatus 1. In other words, the outer casing member 95 constitutes a part of an outer casing of the image forming apparatus 1. The waste toner collection box 96 and the outer casing member 95 are integrally formed.

Grip portions 91a and 91b that can be gripped by the user when the waste toner container 9 is attached and detached are provided at both ends in the Y direction of the outer casing member 95. The grip portions 91a and 91b are arranged outside both ends 21L and 21R of the toner cartridge door 21 in the Y direction.

In the present embodiment, the grip portions 91a and 91b are protruding portions protruding in the Y direction and the −Y direction in a state in which the waste toner container 9 is attached to the apparatus main body 2. Nevertheless, the grip portions 91a and 91b may be recess portions or the like that are recessed in the −Y direction and the Y direction, for example, in place of such a protruding portion. In addition, the grip portions 91a and 91b may be provided at any positions on the outer casing member 95 of the waste toner container 9. Furthermore, the number of grip portions 91a and 91b is not limited to two, and may be one, or three or more.

In addition, in the waste toner collection box 96, metal plate members 92a and 92b functioning as a lock mechanism of the apparatus main body 2 and the waste toner container 9, and waste toner receiving ports 93Y, 93C, 93M, and 93K for receiving waste toner conveyed from the cleaning unit 41 are provided.

The metal plate members 92a and 92b are provided on the downstream end surface of the waste toner container 9 in the −X direction, which is an attachment direction of the waste toner container 9. In addition, in the waste toner collection box 96, a waste toner receiving port 94 for receiving waste toner conveyed from the belt cleaning unit 73 is provided. The waste toner receiving ports 93Y, 93C, 93M, 93K, and 94 have configurations to which the above-described waste toner delivery units 411Y, 411C, 411M, 411K, and 732 provided in the apparatus main body 2 can be attached (refer to FIGS. 3 and 7B).

As illustrated in FIGS. 6, 7A, and 7B, the outer casing member 95 extends in the Y direction and the Z direction, and has a downstream end (i.e., an upper end 9a) in the Z direction of the outer casing member 95. The upper end 9a of the outer casing member 95 is arranged on the upper side of the waste toner delivery units 411Y, 411C, 411M, 411K, and 732. The waste toner delivery units 411Y, 411C, 411M, and 411K constitute a part of the process unit 40 as described above. For this reason, an attaching/detaching locus in attaching/detaching the process unit 40 to or from the apparatus main body 2 in the −X direction or the X direction overlaps the outer casing member 95 of the waste toner container 9 attached to the apparatus main body 2. In a state in which the process unit 40 and the waste toner container 9 are attached to the apparatus main body 2, the outer casing member 95 of the waste toner container 9 is arranged downstream of the process unit 40 in the X direction, which is a removal direction of the process unit 40. Thus, the process unit 40 including a plurality of photosensitive drums 43 cannot be removed from the apparatus main body 2 unless the waste toner container 9 is removed from the apparatus main body 2.

Furthermore, as illustrated in FIGS. 8A and 8B, in the waste toner collection box 96, a waste toner shutter 97 is pivotally provided in such a manner that waste toner does not leak from the waste toner receiving ports 93Y, 93C, 93M, 93K, and 94. One waste toner shutter 97 is provided for each of the waste toner receiving ports 93Y, 93C, 93M, 93K, and 94.

As illustrated in FIGS. 3 and 7B, in the apparatus main body 2, magnet members 212a and 212b functioning as a lock mechanism of the apparatus main body 2 and the waste toner container 9 are provided. The magnet members 212a and 212b are provided on an upstream side surface of the apparatus main body 2 in the −X direction, which is the attachment direction of the waste toner container 9, and can be held by magnetic attraction of the metal plate members 92a and 92b provided in the waste toner container 9, by magnetic force.

In the present embodiment, two metal plate members 92a and 92b, and two magnet members 212a and 212b are provided in such a manner as to be arranged in the Y direction, but the configuration is not limited to this. For example, a direction in which the metal plate members 92a and 92b, and the magnet members 212a and 212b are arranged may be the Z direction.

In addition, the number of metal plate members 92a and 92b, and the number of magnet members 212a and 212b may be one, or three or more, instead of two.

Internal configurations of the waste toner delivery units 411Y, 411C, 411M, 411K, and 732 is described below. The internal configurations of the waste toner delivery units 411Y, 411C, 411M, 411K, and 732 are substantially the same configurations. For this reason, the waste toner delivery unit 411K will be described as a representative, and the description of the internal configurations of the waste toner delivery units 411Y, 411C, 411M, and 732 will be omitted.

As illustrated in FIGS. 8A and 8B, the waste toner delivery unit 411K is provided with a waste toner discharge port 412. On the outer circumferential surface of the waste toner delivery unit 411K, an outer member 413 is supported in such a manner as to be slidable in the X direction, and the outer member 413 is biased by a pressure spring 414 in the X direction. In addition, in the waste toner delivery unit 411K, the waste toner screw 451 is rotatably arranged.

The outer member 413 can move in the X direction and the −X direction between the closed position at which the waste toner discharge port 412 is closed, and the open position at which the waste toner discharge port 412 is opened. As illustrated in FIG. 8B, in a state in which the waste toner container 9 is removed from the apparatus main body 2, the outer member 413 is located at the closed position by the pressure spring 414. For this reason, it is possible to prevent waste toner conveyed by the waste toner screw 451 from leaking from the waste toner discharge port 412 to the outside of the waste toner delivery unit 411K. Furthermore, by the waste toner container 9 being removed from the apparatus main body 2, the waste toner shutter 97 is pivoted by a helical torsion spring (not illustrated) from the open position to the closed position, and the waste toner receiving port 93K is closed. For this reason, it is possible to prevent waste toner in the waste toner collection box 96 from leaking from the waste toner receiving port 93K to the outside of the waste toner container 9.

As illustrated in FIG. 8A, if the waste toner container 9 is attached to the apparatus main body 2, the waste toner shutter 97 is pressed by the waste toner delivery unit 411K to pivot from the closed position to the open position. The waste toner receiving port 93K is accordingly opened. In addition, at a downstream end portion of the outer member 413 in the X direction, a flange portion 413a extending in a direction intersecting with the X direction is provided. An outer diameter of the flange portion 413a is larger than a rim portion of the waste toner receiving port 93K, and the flange portion 413a is never inserted into the waste toner receiving port 93K.

For this reason, if the waste toner container 9 is attached to the apparatus main body 2, the flange portion 413a of the outer member 413 abuts the rim portion of the waste toner receiving port 93K. Thus, the outer member 413 moves relatively in the −X direction with respect to the outer circumferential surface of the waste toner delivery unit 411K against biasing force of the pressure spring 414. The outer member 413 is accordingly located at the open position at which the waste toner discharge port 412 is opened. Accordingly, it becomes possible to discharge waste toner from the waste toner discharge port 412 of the waste toner delivery unit 411K into the waste toner collection box 96.

Next, an operation in which waste toner collected by the cleaning unit 41 and the belt cleaning unit 73 is conveyed to the waste toner collection box 96 and stored in the waste toner collection box 96 will be described. Both of a conveyance operation of waste toner collected by the cleaning unit 41 and a conveyance operation of waste toner collected by the belt cleaning unit 73 are substantially the same operations. For this reason, hereinafter, only a conveyance operation and a storing operation of waste toner in the cleaning unit 41 of the process cartridge 4K will be described.

As illustrated in FIG. 1, waste toner, which is residual toner (primary transfer residual waste toner) that remains on the photosensitive drum 43 of the process cartridge 4K after a primary transfer process, is removed by the cleaning blade 45. The cleaning blade 45 scrapes off the waste toner by coming into contact with the photosensitive drum 43. The waste toner screw 451 of the process cartridge 4K is rotated by a drive unit (not illustrated), and the removed waste toner is conveyed in the X direction through the inside of the waste toner delivery unit 411K in accordance with a rotational operation of the waste toner screw 451. In a case where the waste toner container 9 is attached to the apparatus main body 2, as illustrated in FIG. 8A, waste toner conveyed by the waste toner screw 451 passes through the waste toner discharge port 412 by its own weight, and is stored into the waste toner collection box 96.

Lastly, an attaching/detaching operation of the waste toner container 9 will be described with reference to FIGS. 2, 7, and 8. Regarding the description of operations related to the attachment and detachment of the waste toner container 9 that are to be performed by the waste toner delivery unit 411K and the waste toner delivery unit 732, because the operations to be performed by the two delivery units are approximately the same, only an operation to be performed by the waste toner delivery unit 411K will be described as a representative.

First of all, a removal operation of the waste toner container 9 will be described. As illustrated in FIGS. 7A and 7B, the grip portions 91a and 91b are provided on the left and right of the waste toner container 9. If the user views the image forming apparatus 1 in the −X direction, the user can easily check the positions of the grip portions 91a and 91b. Thus, the user can directly access the grip portions 91a and 91b from a recess portion provided in the apparatus main body 2, without getting confused.

Then, by applying force to the grip portions 91a and 91b in the X direction, as illustrated in FIG. 8B, the user can pull out the waste toner container 9 from the apparatus main body 2 in the X direction. That is, the waste toner container 9 can be removed from the apparatus main body 2 along the X direction, which is one direction of axis line directions of the photosensitive drum 43.

In a state in which the waste toner container 9 is attached to the apparatus main body 2, the magnet members 212a and 212b provided in the apparatus main body 2 and the metal plate members 92a and 92b provided in the waste toner collection box 96 are attracted and held by magnetic force. For this reason, at the stage where force applied by the user in pulling out the waste toner container 9 in the X direction exceeds the magnetic attraction force that acts between the magnet members 212a, 212b and the metal plate members 92a, 92b, the waste toner container 9 can be removed from the apparatus main body 2.

In addition, by the waste toner container 9 being removed from the apparatus main body 2, as illustrated in FIG. 8B, the outer member 413 moves to the closed position at which the waste toner discharge port 412 is closed, and the waste toner shutter 97 moves to the closed position at which the waste toner receiving port 93K is closed. With this configuration, it is possible to prevent waste toner from leaking from the waste toner discharge port 412 to the outside of the waste toner delivery unit 411K, and it is possible to prevent waste toner in the waste toner collection box 96 from leaking from the waste toner receiving port 93K to the outside of the waste toner container 9.

Next, an attaching operation of the waste toner container 9 will be described. As illustrated in FIG. 7B, when an attaching operation of the waste toner container 9 is performed, the user holds the grip portions 91a and 91b, applies force in-the X-axis direction, and moves the waste toner container 9 to the inside of the apparatus main body 2. The grip portions 91a and 91b are provided at grippable positions when the toner cartridge door 21 is at the closed position. If the waste toner container 9 is attached to the apparatus main body 2, the magnet members 212a and 212b provided in the apparatus main body 2 and the metal plate members 92a and 92b provided in the waste toner collection box 96 are stuck by magnetic force, and the position of the waste toner container 9 is fixed.

In addition, by the waste toner container 9 being attached to the apparatus main body 2, as illustrated in FIG. 8A, the outer member 413 moves to the open position at which the waste toner discharge port 412 is opened, and the waste toner shutter 97 moves to the open position at which the waste toner receiving port 93K is opened. Accordingly, simultaneously with an attaching operation of the waste toner container 9, waste toner conveyed by the waste toner screw 451 enters a state in which the waste toner can be stored into the waste toner collection box 96.

In the above description, the attachment and detachment of the waste toner container 9 that are to be performed in a state in which the toner cartridge door 21 is closed have been described, but also in a state in which the toner cartridge door 21 is opened as illustrated in FIG. 2B, the waste toner container 9 can be similarly attached to and detached from the apparatus main body 2. A pivot locus of the toner cartridge door 21 may avoid overlapping the positions of the grip portions 91a and 91b of the waste toner container 9, and an attaching/detaching locus of the waste toner container 9 including the outer casing member 95. In other words, at the closed position, the toner cartridge door 21 is arranged in such a manner as not to overlap both of the waste toner collection box 96 and the outer casing member 95 of the waste toner container 9 when viewed in the X direction being a rotational axis line direction (axis line direction) of the photosensitive drum 43. Furthermore, in other words, the waste toner container 9 is configured to be removable from the apparatus main body 2 at whichever of the closed position and the open position the toner cartridge door 21 is located. That is, the waste toner container 9 can be attached to and detached from the apparatus main body 2 independently of the toner cartridges 5Y, 5C, 5M, and 5K. In addition, the grip portions 91a and 91b are provided at positions grippable by the user at whichever of the closed position and the open position the toner cartridge door 21 is located. Furthermore, the toner cartridge door 21 may serve as a guide in removing (pulling out) the waste toner container 9 from the apparatus main body 2.

### Effect of First Embodiment

As described above, the waste toner container 9 has a configuration in which the waste toner collection box 96 and the outer casing member 95 are integrated. With this configuration, it is possible to improve space efficiency, and increase an amount of waste toner that can be stored in the waste toner container 9, without increasing the size of the apparatus main body 2 of the image forming apparatus 1.

In addition, attachment/detachment workability of the waste toner container 9 can be improved because unnecessary work such as opening/closing of an outer cover (including the toner cartridge door 21) is not required at the time of an exchange work of the waste toner container 9, and it becomes possible to directly attach or detach the waste toner container 9 to or from the apparatus main body 2. In addition, because an outer cover requiring opening and closing to attach or detach the waste toner container 9 does not exist, a lock mechanism for the outer cover becomes unnecessary as well, the configuration of the image forming apparatus 1 can be made simple, and cost can be saved.

Furthermore, because the toner cartridge door 21 is configured to pivot downward from the closed position toward the open position, even if toner adhering to a toner cartridge falls when the toner cartridge is exchanged, the toner can be received on the inner surface of the toner cartridge door 21. With this configuration, it is possible to prevent the periphery of the image forming apparatus 1 such as an external surface of the outer casing member 95 of the waste toner container 9, and an installation surface of the image forming apparatus 1 from soiling.

### Second Embodiment

Next, the second embodiment of the present disclosure will be described. In the second embodiment, an opening/closing direction of the toner cartridge door 21 according to the first embodiment is changed. Thus, the illustration of the components similar to those in the first embodiment is omitted, or such components will be described by allocating the same reference numerals in the drawings.

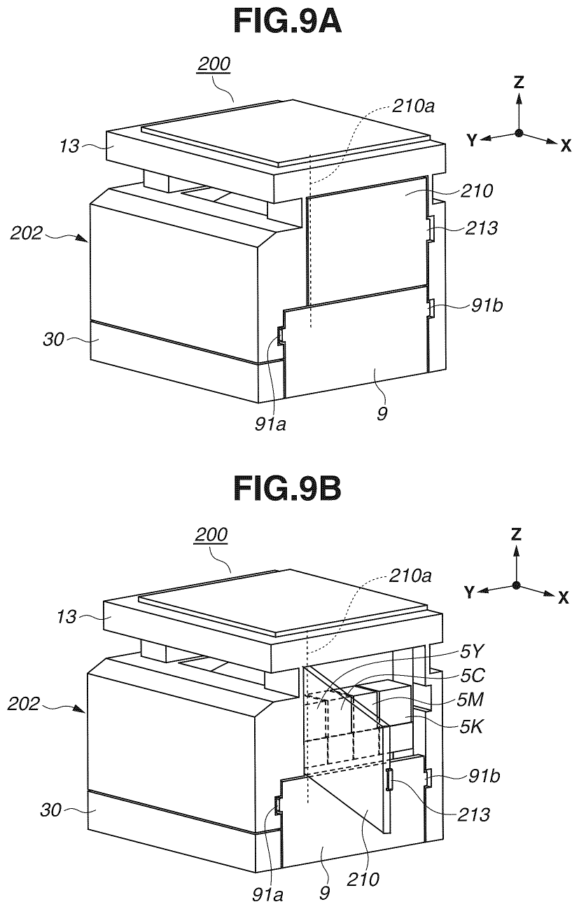

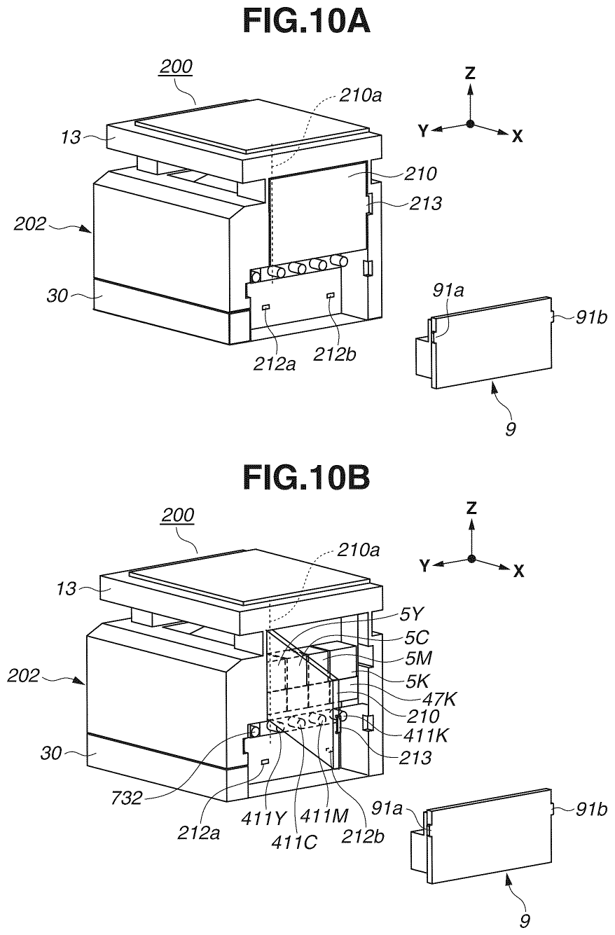

FIG. 9A is a perspective view illustrating an image forming apparatus 200 according to the second embodiment that is in a state in which a toner cartridge door 210 is located at the closed position, and FIG. 9B is a perspective view illustrating the image forming apparatus 200 in a state in which the toner cartridge door 210 is located at the open position. FIG. 10A is a perspective view illustrating the image forming apparatus 200 to which the waste toner container 9 is attached, and FIG. 10B is a perspective view illustrating the image forming apparatus 200 from which the waste toner container 9 is removed.

As illustrated in FIGS. 9A and 9B, on the downstream side surface of an apparatus main body 202 of the image forming apparatus 200 in the X direction, the toner cartridge door 210 and the waste toner container 9 are provided. The toner cartridge door 210 serving as an opening/closing member is arranged above the waste toner container 9, and is provided in such a manner as to be openable and closable about a pivot axis line 210a between a closed position (position illustrated in FIG. 9A) and an open position (position illustrated in FIG. 9B).

The pivot axis line 210a extends in the Z direction and the −Z direction (gravitational force direction), and is located at the downstream end portion (i.e., left end portion) of the toner cartridge door 210 in the Y direction. In other words, the pivot axis line 210a is arranged on the downstream side of the toner cartridge door 210 in the Y direction, which is a draw-out direction of the cassette 30. The toner cartridge door 210 pivots leftward from the closed position toward the open position. The toner cartridge door 210 covers an opening portion 2a of the apparatus main body 202 at the closed position, and opens the opening portion 2a to be exposed to the outside of the apparatus main body 202, at the open position.

### [Attachment and Detachment of Toner Cartridge]

Because an attaching/detaching operation of the toner cartridges 5Y to 5K is similar to that in the first embodiment, the description will be omitted, and the description will be schematically given.

First of all, the removal of the toner cartridge 5 will be described. As illustrated in FIGS. 10A and 10B, the toner cartridge door 210 is provided with a grip portion 213 that can be gripped by the user, and the user can access the grip portion 213 from a recess provided in the apparatus main body 202.

In the present embodiment, the grip portion 213 is a protruding portion protruding leftward when the toner cartridge door 210 is located at the closed position, but the grip portion 213 may be a recess portion or the like that is recessed in the −X direction or the −Y direction, for example, in place of the protruding portion. In addition, the grip portion 213 may be provided at any position on the toner cartridge door 210. Furthermore, the number of grip portions 213 is not limited to one, and a plurality of grip portions 213 may be provided.

In a case where toner in any of the toner cartridges 5Y, 5C, 5M, and 5K runs out, by displaying a message or an image on an operation panel (not illustrated), the image forming apparatus 200 notifies the user of an exchange timing of the toner cartridge 5Y, 5C, 5M, or 5K. If the user accesses the grip portion 213, and pivots the toner cartridge door 210 from the closed position to the open position, a switch (not illustrated) provided on the apparatus main body 202 is turned off. Then, the user becomes able to view the toner cartridges 5Y, 5C, 5M, and 5K attached to the process unit 40, from the opening portion 2a of the apparatus main body 202.

By the user pulling the toner cartridge 5K to be exchanged, for example, upward in the Z direction (i.e., gravitational force direction), it is possible to remove the toner cartridge 5K from the process unit 40 in such a manner as to follow the side surface 48 of the attachment portion 47K. That is, when the toner cartridge 5K is attached to or detached from the process unit 40, the side surface 48 of the attachment portion 47K guides the toner cartridge 5K.

Next, the attachment of the toner cartridge 5K will be described. First of all, the user pushes the toner cartridge 5K downward in the −Z direction (i.e., vertical direction) in such a manner as to follow the side surface 48 of the attachment portion 47K provided in the process unit 40. The toner cartridge 5K is guided by the side surface 48 of the attachment portion 47K, and the toner cartridge 5K is inserted at a predetermined position of the process unit 40.

After the attachment of the toner cartridge 5K to the attachment portion 47K ends, the user pivots the toner cartridge door 210 from the open position to the closed position. Accordingly, an apparatus main body switch (not illustrated) is pressed, and the image forming apparatus 200 automatically starts toner supply from the toner cartridge 5K to the process unit 40. The image forming apparatus 200 thereby enters a state of being able to normally start printing, and an attaching operation of the toner cartridge 5K is completed.

### [Attachment and Detachment of Waste Toner Container]

Next, an attaching/detaching operation of the waste toner container 9 will be described with reference to FIGS. 10A and 10B. Because the configuration and an attaching/detaching operation of the waste toner container 9 are similar to those in the first embodiment, the description will be omitted, and the description will be schematically given.

First of all, a removal operation of the waste toner container 9 will be described. As illustrated in FIGS. 10A and 10B, the grip portions 91a and 91b are provided at the left and right of the waste toner container 9. If the user views the image forming apparatus 200 in the −X direction, the user can easily check the positions of the grip portions 91a and 91b. Thus, the user can directly access the grip portions 91a and 91b from a recess portion provided in the apparatus main body 202, without getting confused. In addition, the grip portion 91a being one of the grip portions 91a and 91b is arranged downstream of the pivot axis line 210a in the Y direction, which is a draw-out direction of the cassette 30.

Then, by applying force to the grip portions 91a and 91b in the X direction, as illustrated in FIG. 10B, the user can pull out the waste toner container 9 from the apparatus main body 202 in the X direction. In the present embodiment, the toner cartridge door 210 pivots in the approximately-horizontal direction about the pivot axis line 210a extending in the Z direction. For this reason, a pivot locus of the toner cartridge door 210 never overlaps the positions of the grip portions 91a and 91b of the waste toner container 9, and an attaching/detaching locus of the waste toner container 9. Accordingly, if the user views the image forming apparatus 200 in the −X direction, the user can easily check the positions of the grip portions 91a and 91b. Thus, the user can directly access the grip portions 91a and 91b from a recess portion provided in the apparatus main body 202, without getting confused. In addition, the user can easily remove the waste toner container 9.

Similarly, regarding an attaching operation of attaching the waste toner container 9 to the apparatus main body 202, a pivot locus of the toner cartridge door 210 never overlaps the positions of the grip portions 91a and 91b of the waste toner container 9, and an attaching/detaching locus of the waste toner container 9.

Accordingly, at whichever of the closed position and the open position, the toner cartridge door 210 is arranged in such a manner as not to overlap both of the waste toner collection box 96 and the outer casing member 95 of the waste toner container 9 when viewed in the X direction, which is a rotational axis line direction (axis line direction) of the photosensitive drum 43. In addition, the waste toner container 9 is configured to be removable from the apparatus main body 202 at whichever of the closed position and the open position the toner cartridge door 210 is located. That is, the waste toner container 9 can be attached to and detached from the apparatus main body 202 independently of the toner cartridges 5Y, 5C, 5M, and 5K. In addition, the grip portions 213 are provided at a position grippable by the user at whichever of the closed position and the open position the toner cartridge door 210 is located.

### Effect of Second Embodiment

As described above, the toner cartridge door 210 pivots in the approximately-horizontal direction about the pivot axis line 210a extending in the Z direction. For this reason, the user can attach or detach the waste toner container 9 to or from the apparatus main body 202 irrespective of an opened/closed state of the toner cartridge door 210, and attachment/detachment workability of the waste toner container 9 can be improved. In addition, an effect similar to that of the first embodiment can be obtained.

### Other Embodiments

In all of the above-described embodiments, the image forming apparatuses 1 and 200 are provided with the cleaning blade 45 and the belt cleaning unit 73, but the configuration is not limited to this. For example, the image forming apparatuses 1 and 200 are only required to be provided with at least either one of the cleaning blade 45 and the belt cleaning unit 73.

In addition, in all of the above-described embodiments, as a lock mechanism of an apparatus main body and the waste toner container 9, the configurations of the metal plate members 92 and the magnet members 212 have been described, but another lock mechanism such as a hook may be used.

In addition, in all of the above-described embodiments, an image forming apparatus provided with the document reading unit 13 has been described, but an image forming apparatus not provided with the document reading unit 13 may be used.

In addition, in all of the above-described embodiments, the toner cartridges 5Y, 5C, 5M, and 5K are configured to be attached to the attachment portions 47Y, 47C, 47M, and 47K in the −Z direction, and detached from the attachment portions 47Y, 47C, 47M, and 47K in the Z direction, but the configuration is not limited to this. For example, the toner cartridges 5Y, 5C, 5M, and 5K may be configured to be attached to and detached from the attachment portions 47Y, 47C, 47M, and 47K while pivoting.

In addition, in the first embodiment, the toner cartridge door 21 is configured to pivot from the closed position toward the open position by pivoting downward with respect to the apparatus main body 2, but the configuration is not limited to this. For example, the toner cartridge door 21 may be configured to pivot from the closed position toward the open position by pivoting upward with respect to the apparatus main body 2.

In addition, in the second embodiment, the pivot axis line 210a of the toner cartridge door 210 is located at the downstream end portion of the toner cartridge door 210 in the Y direction, but the configuration is not limited to this. For example, the pivot axis line 210a of the toner cartridge door 210 may be located at an upstream end portion of the toner cartridge door 210 in the Y direction.

### Sum-Up of Present Disclosure

The present disclosure at least includes the following.

### (Configuration 1)

An image forming apparatus including:
an apparatus main body;
   an outer casing member constituting an outer casing of the image forming apparatus;
a toner container detachably attached to the apparatus main body; and
   a residual toner container detachably attached to the apparatus main body independently of the toner container,
wherein the apparatus main body includes
   a photosensitive drum rotatable about a rotational axis line extending in an axis line direction intersecting with a gravitational force direction,
a belt to which a toner image on the photosensitive drum is to be transferred,
   a transfer member for transferring a toner image on the belt to a recording material,
a development unit configured to develop a toner image by supplying toner to the photosensitive drum,
a toner storage unit configured to store toner to be borne by the development unit, and
   at least either one of a collection member configured to collect residual toner remaining on the belt without being transferred to a recording material and a blade configured to scrape off residual toner remaining on the photosensitive drum without being transferred to the belt, by coming into contact with the photosensitive drum,
wherein the toner container stores toner to be supplied to the toner storage unit,
   wherein the residual toner container stores at least either one of residual toner scraped off by the blade on the photosensitive drum and residual toner collected by the collection member from the belt, and is provided on one end side of the photosensitive drum in the axis line direction,
wherein a removing direction of the toner container from the apparatus main body is an upper direction of the gravitational force direction, and
   wherein a part of the outer casing member is attached to the residual toner container.

### (Configuration 2)

The image forming apparatus according to Configuration 1, wherein the residual toner container is removable from the apparatus main body in a direction extending along the axis line direction.

### (Configuration 3)

The image forming apparatus according to Configuration 1 or 2,
wherein the photosensitive drum, the development unit, the toner storage unit, and the toner container are a first photosensitive drum, a first development unit, a first toner storage unit, and a first toner container, respectively,
   wherein the apparatus main body includes a second photosensitive drum configured to bear a toner image of a color different from a color of a toner image on the first photosensitive drum, a second development unit configured to develop a toner image by supplying toner to the second photosensitive drum, and a second toner storage unit configured to store toner to be borne by the second development unit, and
wherein the image forming apparatus further includes a second toner container that is configured to store toner to be supplied to the second toner storage unit and is detachably attached to the apparatus main body.

### (Configuration 4)

The image forming apparatus according to Configuration 3,
wherein the first photosensitive drum and the second photosensitive drum are arranged in a first intersecting direction intersecting with both of the gravitational force direction and the axis line direction, and
wherein the first toner container and the second toner container are arranged in a second intersecting direction intersecting with both of the gravitational force direction and the axis line direction.

### (Configuration 5)

The image forming apparatus according to Configuration 4, wherein the first intersecting direction and the second intersecting direction are same directions as each other.

### (Configuration 6)

The image forming apparatus according to any one of Configurations 3 to 5, wherein the apparatus main body includes a process unit that includes the first photosensitive drum and the second photosensitive drum and is configured to be removable from a casing of the apparatus main body.

### (Configuration 7)

The image forming apparatus according to any one of Configurations 1 to 6, wherein the photosensitive drum is non-removable from a casing of the apparatus main body unless the residual toner container is removed from the apparatus main body.

### (Configuration 8)

The image forming apparatus according to any one of Configurations 1 to 7, wherein the toner container is arranged above the residual toner container.

### (Configuration 9)

An image forming apparatus including:
an apparatus main body including an attachment portion;
   an outer casing member constituting an outer casing of the image forming apparatus;
a toner container detachably attached to the attachment portion of the apparatus main body; and
   a residual toner container detachably attached to the apparatus main body independently of the toner container,
wherein the apparatus main body includes
   a photosensitive drum rotatable about a rotational axis line extending in an axis line direction intersecting with a gravitational force direction,
a belt to which a toner image on the photosensitive drum is to be transferred,
   a transfer member for transferring a toner image on the belt to a recording material,
a development unit configured to develop a toner image by supplying toner to the photosensitive drum,
a toner storage unit configured to store toner to be borne by the development unit,
   at least either one of a collection member configured to collect residual toner remaining on the belt without being transferred to a recording material and a blade configured to scrape off residual toner remaining on the photosensitive drum without being transferred to the belt, by coming into contact with the photosensitive drum, and
   an opening/closing member movable between a closed position at which the attachment portion is closed and an open position at which the attachment portion is opened,
wherein the toner container stores toner to be supplied to the toner storage unit,
   wherein the residual toner container stores at least either one of residual toner scraped off by the blade on the photosensitive drum and residual toner collected by the collection member from the belt, and is provided on one end side of the photosensitive drum in the axis line direction,
   wherein a part of the outer casing member is attached to the residual toner container, and
   wherein the residual toner container is configured to be removable from the apparatus main body when the opening/closing member is located at the closed position.

### (Configuration 10)

The image forming apparatus according to Configuration 9, wherein, when the opening/closing member is located at the closed position, the opening/closing member is arranged in such a manner as not to overlap both of the residual toner container and the part of the outer casing member when viewed in the axis line direction.

### (Configuration 11)

The image forming apparatus according to Configuration 9 or 10,
wherein the part of the outer casing member includes a grip portion, and
   wherein the grip portion is provided at a grippable position when the opening/closing member is at the closed position.

### (Configuration 12)

The image forming apparatus according to Configuration 11, wherein the grip portions are provided at both ends of the outer casing member in a direction intersecting with both of the gravitational force direction and the axis line direction.

### (Configuration 13)

The image forming apparatus according to any one of Configurations 9 to 12, wherein the residual toner container is removable from the apparatus main body in a direction extending along the axis line direction.

### (Configuration 14)

The image forming apparatus according to any one of Configurations 9 to 13, wherein a removing direction of the toner container from the apparatus main body is an upper direction of the gravitational force direction.

### (Configuration 15)

An image forming apparatus includes:
an apparatus main body including an attachment portion;
   an outer casing member constituting an outer casing of the image forming apparatus;
a toner container detachably attached to the attachment portion of the apparatus main body; and
   a residual toner container detachably attached to the apparatus main body independently of the toner container,
wherein the apparatus main body includes
   a photosensitive drum rotatable about a rotational axis line extending in an axis line direction intersecting with a gravitational force direction,
a belt to which a toner image on the photosensitive drum is to be transferred,
   a transfer member for transferring a toner image on the belt to a recording material,
a development unit configured to develop a toner image by supplying toner to the photosensitive drum,
a toner storage unit configured to store toner to be borne by the development unit,
   at least either one of a collection member configured to collect residual toner remaining on the belt without being transferred to a recording material and a blade configured to scrape off residual toner remaining on the photosensitive drum without being transferred to the belt, by coming into contact with the photosensitive drum, and
   an opening/closing member that is movable between a closed position at which the attachment portion is closed and an open position at which the attachment portion is opened, and is configured to pivot from the closed position toward the open position by pivoting downward in the gravitational force direction with respect to the apparatus main body,
wherein the toner container stores toner to be supplied to the toner storage unit,
   wherein the residual toner container stores at least either one of residual toner scraped off by the blade on the photosensitive drum and residual toner collected by the collection member from the belt, and is provided on one end side of the photosensitive drum in the axis line direction, and
      wherein a part of the outer casing member is attached to the residual toner container.

### (Configuration 16)

The image forming apparatus according to Configuration 15, wherein, when the opening/closing member is located at the closed position, the opening/closing member is arranged in such a manner as not to overlap both of the residual toner container and the part of the outer casing member when viewed in the axis line direction.

### (Configuration 17)

The image forming apparatus according to Configuration 15 or 16, wherein, when the opening/closing member is located at the open position, the opening/closing member is arranged in such a manner as not to overlap both of the residual toner container and the part of the outer casing member when viewed in the axis line direction.

### (Configuration 18)

The image forming apparatus according to any one of Configurations 15 to 17,
wherein the part of the outer casing member includes a grip portion, and
   wherein the grip portion is provided at a grippable position when the opening/closing member is at the closed position.

### (Configuration 19)

The image forming apparatus according to Configuration 18, wherein the grip portion is provided at a grippable position when the opening/closing member is at the closed position.

### (Configuration 20)

The image forming apparatus according to Configuration 18 or 19, wherein the grip portion is provided on an outside of both ends of the opening/closing member in a direction intersecting with both of the gravitational force direction and the axis line direction.

### (Configuration 21)

The image forming apparatus according to any one of Configurations 17 to 20, wherein the residual toner container is removable from the apparatus main body in a direction extending along the axis line direction.

### (Configuration 22)

An image forming apparatus includes:
an apparatus main body including an attachment portion;
   an outer casing member constituting an outer casing of the image forming apparatus;
a toner container detachably attached to the attachment portion of the apparatus main body; and
   a residual toner container detachably attached to the apparatus main body independently of the toner container,
wherein the apparatus main body includes
   a photosensitive drum rotatable about a rotational axis line extending in an axis line direction intersecting with a gravitational force direction,
a belt to which a toner image on the photosensitive drum is to be transferred,
   a transfer member for transferring a toner image on the belt to a recording material,
a development unit configured to develop a toner image by supplying toner to the photosensitive drum,
a toner storage unit configured to store toner to be borne by the development unit,
   at least either one of a collection member configured to collect residual toner remaining on the belt without being transferred to a recording material and a blade configured to scrape off residual toner remaining on the photosensitive drum without being transferred to the belt, by coming into contact with the photosensitive drum, and
   an opening/closing member that is movable between a closed position at which the attachment portion is closed and an open position at which the attachment portion is opened, and is configured to be pivotable about a pivot axis line extending in the gravitational force direction,
wherein the toner container stores toner to be supplied to the toner storage unit,
   wherein the residual toner container stores at least either one of residual toner scraped off by the blade on the photosensitive drum and residual toner collected by the collection member from the belt, and is provided on one end side of the photosensitive drum in the axis line direction, and
      wherein a part of the outer casing member is attached to the residual toner container.

### (Configuration 23)

The image forming apparatus according to Configuration 22, wherein, when the opening/closing member is located at the closed position, the opening/closing member is arranged in such a manner as not to overlap both of the residual toner container and the part of the outer casing member when viewed in the axis line direction.

### (Configuration 24)

The image forming apparatus according to Configuration 22 or 23, wherein, when the opening/closing member is located at the open position, the opening/closing member is arranged in such a manner as not to overlap both of the residual toner container and the part of the outer casing member when viewed in the axis line direction.

### (Configuration 25)

The image forming apparatus according to any one of Configurations 22 to 24, wherein the residual toner container is removable from the apparatus main body in a direction extending along the axis line direction.

### (Configuration 26)

The image forming apparatus according to any one of Configurations 22 to 25,
wherein the part of the outer casing member includes a grip portion, and
   wherein the grip portion is provided at a grippable position when the opening/closing member is at the closed position.

### (Configuration 27)

The image forming apparatus according to Configuration 26, wherein the grip portion is provided at a grippable position when the opening/closing member is at the open position.

### (Configuration 28)

The image forming apparatus according to Configuration 26 or 27,
wherein the apparatus main body includes a drawer unit that is configured to store a recording material to which a toner image is to be transferred by the transfer member, and provided in such a manner as to be drawable in a draw-out direction with respect to a casing of the apparatus main body, and
   wherein at least a part of the grip portion is arranged downstream of the opening/closing member the pivot axis line in the draw-out direction.

### (Configuration 29)

The image forming apparatus according to any one of Configurations 22 to 28,
wherein the apparatus main body includes a drawer unit that is configured to store a recording material to which a toner image is to be transferred by the transfer member, and provided in such a manner as to be drawable in a draw-out direction with respect to a casing of the apparatus main body, and
   wherein the pivot axis line is arranged on a downstream side of the opening/closing member in the draw-out direction.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-224575, filed Dec. 19, 2024, which is hereby incorporated by reference herein in its entirety.

What is claimed is:

1. An image forming apparatus comprising:
an apparatus main body;
an outer casing member constituting an outer casing of the image forming apparatus;
a toner container detachably attached to the apparatus main body; and
a residual toner container detachably attached to the apparatus main body independently of the toner container,
wherein the apparatus main body includes
a photosensitive drum rotatable about a rotational axis line extending in an axis line direction intersecting with a gravitational force direction,
a belt to which a toner image on the photosensitive drum is to be transferred,
a transfer member for transferring a toner image on the belt to a recording material,
a development unit configured to develop a toner image by supplying toner to the photosensitive drum,
a toner storage unit configured to store toner to be borne by the development unit, and
at least either one of a collection member configured to collect residual toner remaining on the belt without being transferred to a recording material and a blade configured to scrape off residual toner remaining on the photosensitive drum without being transferred to the belt, by coming into contact with the photosensitive drum,
wherein the toner container stores toner to be supplied to the toner storage unit,
wherein the residual toner container stores at least either one of residual toner scraped off by the blade on the photosensitive drum and residual toner collected by the collection member from the belt, and is provided on one end side of the photosensitive drum in the axis line direction,
wherein a removing direction of the toner container from the apparatus main body is an upper direction of the gravitational force direction, and
wherein a part of the outer casing member is attached to the residual toner container.

2. The image forming apparatus according to claim 1, wherein the residual toner container is removable from the apparatus main body in a direction extending along the axis line direction.

3. The image forming apparatus according to claim 1,
wherein the photosensitive drum, the development unit, the toner storage unit, and the toner container are a first photosensitive drum, a first development unit, a first toner storage unit, and a first toner container, respectively,
wherein the apparatus main body includes a second photosensitive drum configured to bear a toner image of a color different from a color of a toner image on the first photosensitive drum, a second development unit configured to develop a toner image by supplying toner to the second photosensitive drum, and a second toner storage unit configured to store toner to be borne by the second development unit, and
wherein the image forming apparatus further includes a second toner container that is configured to store toner to be supplied to the second toner storage unit and is detachably attached to the apparatus main body.

4. The image forming apparatus according to claim 3,
wherein the first photosensitive drum and the second photosensitive drum are arranged in a first intersecting direction intersecting with both of the gravitational force direction and the axis line direction, and
wherein the first toner container and the second toner container are arranged in a second intersecting direction intersecting with both of the gravitational force direction and the axis line direction.

5. The image forming apparatus according to claim 4, wherein the first intersecting direction and the second intersecting direction are same directions as each other.

6. The image forming apparatus according to claim 3, wherein the apparatus main body includes a process unit that includes the first photosensitive drum and the second photosensitive drum and is configured to be removable from a casing of the apparatus main body.

7. The image forming apparatus according to claim 1, wherein the photosensitive drum is non-removable from a casing of the apparatus main body unless the residual toner container is removed from the apparatus main body.

8. The image forming apparatus according to claim 1, wherein the toner container is arranged above the residual toner container.

9. An image forming apparatus comprising:
an apparatus main body including an attachment portion;
an outer casing member constituting an outer casing of the image forming apparatus;
a toner container detachably attached to the attachment portion of the apparatus main body; and
a residual toner container detachably attached to the apparatus main body independently of the toner container,
wherein the apparatus main body includes
a photosensitive drum rotatable about a rotational axis line extending in an axis line direction intersecting with a gravitational force direction,
a belt to which a toner image on the photosensitive drum is to be transferred,
a transfer member for transferring a toner image on the belt to a recording material,
a development unit configured to develop a toner image by supplying toner to the photosensitive drum,
a toner storage unit configured to store toner to be borne by the development unit,
at least either one of a collection member configured to collect residual toner remaining on the belt without being transferred to a recording material and a blade configured to scrape off residual toner remaining on the photosensitive drum without being transferred to the belt, by coming into contact with the photosensitive drum, and
an opening/closing member movable between a closed position at which the attachment portion is closed and an open position at which the attachment portion is opened,
wherein the toner container stores toner to be supplied to the toner storage unit,
wherein the residual toner container stores at least either one of residual toner scraped off by the blade on the photosensitive drum and residual toner collected by the collection member from the belt, and is provided on one end side of the photosensitive drum in the axis line direction,
wherein a part of the outer casing member is attached to the residual toner container, and
wherein the residual toner container is configured to be removable from the apparatus main body when the opening/closing member is located at the closed position.

10. The image forming apparatus according to claim 9, wherein, when the opening/closing member is located at the closed position, the opening/closing member is arranged in such a manner as not to overlap both of the residual toner container and the part of the outer casing member when viewed in the axis line direction.

11. The image forming apparatus according to claim 9,
wherein the part of the outer casing member includes a grip portion, and
wherein the grip portion is provided at a grippable position when the opening/closing member is at the closed position.

12. The image forming apparatus according to claim 11, wherein the grip portions are provided at both ends of the outer casing member in a direction intersecting with both of the gravitational force direction and the axis line direction.

13. The image forming apparatus according to claim 9, wherein the residual toner container is removable from the apparatus main body in a direction extending along the axis line direction.

14. The image forming apparatus according to claim 9, wherein a removing direction of the toner container from the apparatus main body is an upper direction of the gravitational force direction.
